(19) United States
(12) Patent Application Publication
(10) Pub. No.: US 2025/0243701 A1
(43) Pub. Date: Jul. 31, 2025

(54) Adjustable Closure Bumper Including Locking Nut

(71) Applicant: Newfrey LLC, New Britain, CT (US)

(72) Inventors: James D. CARLSON, Troy, MI (US); Tien T. Diep, West Bloomfield Township, MI (US); Kranthi Santapuri, Troy, MI (US)

(73) Assignee: Newfrey LLC, New Britain, CT (US)

(21) Appl. No.: 19/020,298

(22) Filed: Jan. 14, 2025

Related U.S. Application Data
(60) Provisional application No. 63/625,122, filed on Jan. 25, 2024.

(51) Int. Cl. E05F 5/06

(52) U.S. Cl. CPC E05F 5/06

(57) ABSTRACT

An adjustable closure bumper includes a base, a stem, a bump stop, a ratchet mechanism, and a locking nut. The base is mountable to a body panel adjacent to an opening for a closure panel. The stem is insertable into a receptacle in the base. The bump stop is attached to one end of the stem for engaging the closure panel. The ratchet mechanism allows the stem to move into the receptacle in the base to adjust a height of the adjustable closure bumper while inhibiting movement of the stem out of the receptacle. The locking nut fits over a portion of the base forming the receptacle and is rotatable relative to the base to lockout the ratchet mechanism and thereby set the height of the adjustable closure bumper.

### CROSS-REFERENCE TO RELATED APPLICATIONS

This application claims the benefit of U.S. Provisional Application No. 63/625,122, filed on Jan. 25, 2024. The entire disclosure of the application referenced above is incorporated herein by reference.

### FIELD

The present disclosure relates to an adjustable closure bumper including a locking nut.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

An adjustable closure bumper is mountable to a body panel adjacent to an opening for a closure panel, such a liftgate, and provides a desired fit and finish between the body and closure panels. The height of the bumper is adjustable to accommodate various fits between the body and closure panels. Screw-in closure bumpers include a base with a hole, a threaded stem that threads into the hole in the base, and a bump stop attached to one end of the stem. The base is attachable to the body panel adjacent to the closure panel opening, and the bump stop engages the closure panel as the closure panel closes. The height of the bumper is adjusted by tightening or loosening the threaded stem into or out of the threaded hole in the base. The process for adjusting the height of screw-in closure bumpers requires trial-and-error and can be time-consuming and tedious.

In an attempt to overcome these issues, closure bumpers have been developed that include a ratchet mechanism for adjusting the height of the stem relative to the base more quickly and easily than screw-in closure bumpers. Ratcheting closure bumpers typically include a feature for locking out the ratchet mechanism and thereby setting the height of the closure bumper. One such closure bumper includes two sets of threads that extend partially around the stem—one set of flexible threads and another set of rigid threads—and a base with a hole having internal threads that extend only partially around the hole. The flexible threads deflect as they are moved past internal threads in the base, and thereby act as a ratchet mechanism. The rigid threads prevent axial movement of the stem when the rigid threads engage the internal threads in the base. The height of the closure bumper is set by rotating the stem to disengage the flexible threads and engage the rigid threads. The lockout feature for these types of closure bumpers can become inadvertently engaged, which can increase assembly time and cause damage to the closure bumper.

### SUMMARY

An example of an adjustable closure bumper according to the present disclosure includes a base, a stem, a bump stop, a ratchet mechanism, and a locking nut. The base is mountable to a body panel adjacent to an opening for a closure panel. The stem is insertable into a receptacle in the base. The bump stop is attached to one end of the stem for engaging the closure panel. The ratchet mechanism allows the stem to move into the receptacle in the base to adjust a height of the adjustable closure bumper while inhibiting movement of the stem out of the receptacle. The locking nut fits over a portion of the base forming the receptacle and is rotatable relative to the base to lockout the ratchet mechanism and thereby set the height of the adjustable closure bumper.

In one aspect, the base defines a pair of grooves spaced apart from one another around a perimeter of the base, and the locking nut includes a positioning protrusion that projects radially inward, the positioning protrusion disengaging one of the grooves and engaging the other one of the grooves when the locking nut is rotated between its unlocked position and its locked position.

In one aspect, the base includes a retention protrusion disposed between the grooves about the perimeter of the base, and the locking nut defines a slot adjacent to the positioning protrusion, the slot enabling the positioning protrusion to deflect radially outward and move past the retention protrusion when the locking nut is rotated between its unlocked position and its locked position.

In one aspect, a leading edge of the retention protrusion has a lesser slope angle than a trailing edge of the retention protrusion.

In one aspect, the base includes a plurality of fingers that define the receptacle, each finger having internal threads that engage external threads on the stem and, as the stem is inserted into the receptacle in the base, the fingers are configured to deflect radially outward and inward each time that one of the external threads of the stem moves past one of the internal threads of the fingers, the fingers and the external threads of the stem forming the ratchet mechanism.

In one aspect, the locking nut includes a plurality of locking protrusions that project radially inward, the locking protrusions and the fingers are radially spaced apart by a gap when the locking nut is in its unlocked position, and the gap is eliminated when the locking nut is in its locked position.

In one aspect, the fingers have a variable outer diameter and the locking protrusions have a variable inner diameter.

In one aspect, each finger includes a rotational stop disposed on an outer radial surface thereof, the rotational stops contacting the locking protrusions to stop rotation of the locking nut when the locking nut is rotated from its unlocked position to its locked position.

In one aspect, each finger includes a retention flange, the retention flanges on the fingers engaging an axial end surface of the locking nut and thereby retain the locking nut on the base when the locking nut is slid onto the base past the retention flanges.

In one aspect, when the locking nut is in its locked position, the force required to compress the bump stop is less than the force required to move the external threads of the stem past the internal threads of the fingers.

In one aspect, the base includes a cylindrical portion defining a ledge, the locking nut fits over the cylindrical portion of the base, and as the locking nut is slid onto the cylindrical portion, the ledge of the cylindrical portion engages an axial end surface of the locking nut and thereby prevents the locking nut from being slid further onto the cylindrical portion.

In one aspect, the base further includes an oblong portion from which the cylindrical portion projects, the oblong portion having a pair of counterbores configured to receive fasteners for securing the base to the body panel.

In one aspect, the ratcheting mechanism is formed by the base and the stem.

In one aspect, the base and the stem are made from a plastic, the locking nut is made from a thermoplastic, and the bump stop is made from a rubber.

In one aspect, the locking nut has an annular body with an inner radial surface, and outer radial surface, and a plurality of knurls projecting from the outer radial surface for rotating the locking nut by hand.

Another example of an adjustable closure bumper according to the principal of the present disclosure includes a base, a stem, a bump stop, and a locking nut. The base is mountable to a body panel adjacent to an opening for a closure panel. The base includes a cylindrical portion having a receptacle. The stem is insertable into the receptacle in the base. The bump stop is attached to one end of the stem for engaging the closure panel. The locking nut fits over the cylindrical portion of the base and is rotatable relative to the cylindrical portion between an unlocked position and a locked position. The stem is axially moveable within the receptacle to adjust a height of the adjustable closure bumper when the locking nut is in its unlocked position. The stem is axially immoveable within the receptacle when the locking nut is in its locked position such that adjusting the locking nut from its unlocked position to its locked position sets the height of the adjustable closure bumper.

In one aspect, the cylindrical portion of the base defines a pair of grooves spaced apart from one another around a perimeter of the cylindrical portion, and the locking nut includes a positioning protrusion that projects radially inward, the positioning protrusion disengaging one of the grooves and engaging the other one of the grooves when the locking nut is rotated between its unlocked position and its locked position.

In one aspect, the cylindrical portion of the base includes a retention protrusion disposed between the grooves about the perimeter of the base, and the locking nut defines a slot adjacent to the positioning protrusion, the slot enabling the positioning protrusion to deflect radially outward and move past the retention protrusion when the locking nut is rotated between its unlocked position and its locked position.

In one aspect, the base includes a plurality of fingers that define the receptacle, each finger having internal threads that engage external threads on the stem and, as the stem is inserted into the receptacle in the base, the fingers are configured to deflect radially outward and inward each time that one of the external threads of the stem moves past one of the internal threads of the fingers.

In one aspect, the locking nut includes a plurality of locking protrusions that project radially inward, the locking protrusions and the fingers are radially spaced apart by a gap when the locking nut is in its unlocked position, and the gap is eliminated when the locking nut is in its locked position.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a perspective view of an adjustable closure bumper according to the principles of the present disclosure, the adjustable closure bumper including a base, a locking nut, a threaded stem, a bump stop, and a pair of washers;

FIG. 2 is an exploded perspective view of the adjustable closure bumper of FIG. 1;

FIG. 3 is a perspective view of the base and locking nut of FIG. 1;

FIG. 4 is a perspective view of the base of FIG. 1;

FIG. 5 is a section view of the adjustable closure bumper of FIG. 1 taken along a line A-A shown in FIG. 1;

FIG. 6 is a sectioned perspective view of the adjustable closure bumper of FIG. 1 taken along a line B-B shown in FIG. 5, with the locking nut in its unlocked position;

FIG. 7 is a sectioned perspective view of the adjustable closure bumper of FIG. 1 taken along the line B-B shown in FIG. 5, with the locking nut in its locked position;

FIG. 8 is a sectioned perspective view of the adjustable closure bumper of FIG. 1 taken along a line C-C shown in FIG. 5, with the locking nut in its unlocked position; and

FIG. 9 is a sectioned perspective view of the adjustable closure bumper of FIG. 1 taken along the line C-C shown in FIG. 5, with the locking nut in its locked position.

In the drawings, reference numbers may be reused to identify similar and/or identical elements.

### DETAILED DESCRIPTION

An adjustable closure bumper according to the present disclosure includes a ratchet mechanism for adjusting the bumper height more quickly and easily than screw-in closure bumpers. In addition, the adjustable closure bumper includes a locking nut for locking out the ratchet mechanism and thereby setting the bumper height. The locking nut is less likely to become inadvertently engaged relative to other ratcheting closure bumpers, which reduces assembly time and prevents damage. Furthermore, the locking nut is easy to adjust between its locked and unlocked positions.

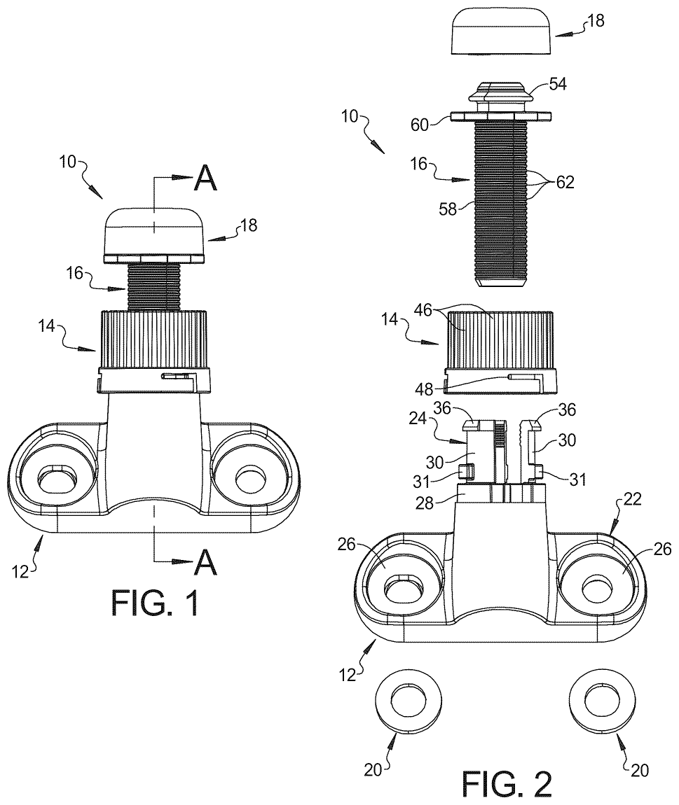

Referring to FIGS. 1 through 5, an adjustable closure bumper 10 is mountable to a body panel (not shown) adjacent to an opening for a closure panel (not shown), such a liftgate, and provides a desired fit and finish between the body panel and the closure panel. The bumper 10 includes a base 12, a locking nut 14, a threaded stem 16, a bump stop 18, and a pair of washers 20. The base 12 and the stem 16 can be made from a plastic such as 15 percent glass-filled nylon 6. The locking nut 14 can be made from a thermoplastic such as polyoxymethylene. The bump stop 18 can be made from a rubber such as ethylene propylene diene monomer rubber. The washers 20 can be made from a foam such as closed cell foam.

The base 12 includes an oblong portion 22 and a cylindrical portion 24 projecting from one side of the oblong portion 22. The oblong portion 22 of the base 12 has a pair of counterbores 26 configured to receive fasteners (not shown), such as screws, for securing the base 12 to the body panel. In this regard, the oblong portion 22 of the base 12 may be referred to as the body panel mounting portion. The counterbores 26 are double sided, and the backsides of the counterbores 26 (i.e., the sides not shown in FIGS. 1 and 2) are configured to receive the washers 20. In various implementations, the base 12 may not include the oblong portion 22 and/or the base 12 may be secured to the body panel using features other than fasteners. For example, the cylindrical portion 24 may include a flange that engages the outer surface of the body panel and tabs that engage a backside of the body panel when the cylindrical portion 24 is inserted into a hole in the body panel and rotated relative thereto.

The cylindrical portion 24 of the base 12 includes a variable diameter portion 28, three fingers 30 equally spaced apart from one another around the circumference of the cylindrical portion 24, and a rotational stop 31 disposed on the outer radial surface of each finger 30. As best shown in FIG. 4, the variable diameter portion 28 includes three pairs of axially extending grooves 32 and three retention protrusions 34, with each retention protrusion 34 disposed circumferentially between the grooves 32 of one of the pairs. Each finger 30 has a retention flange 36 and internal threads 38 in the form of annular rib segments.

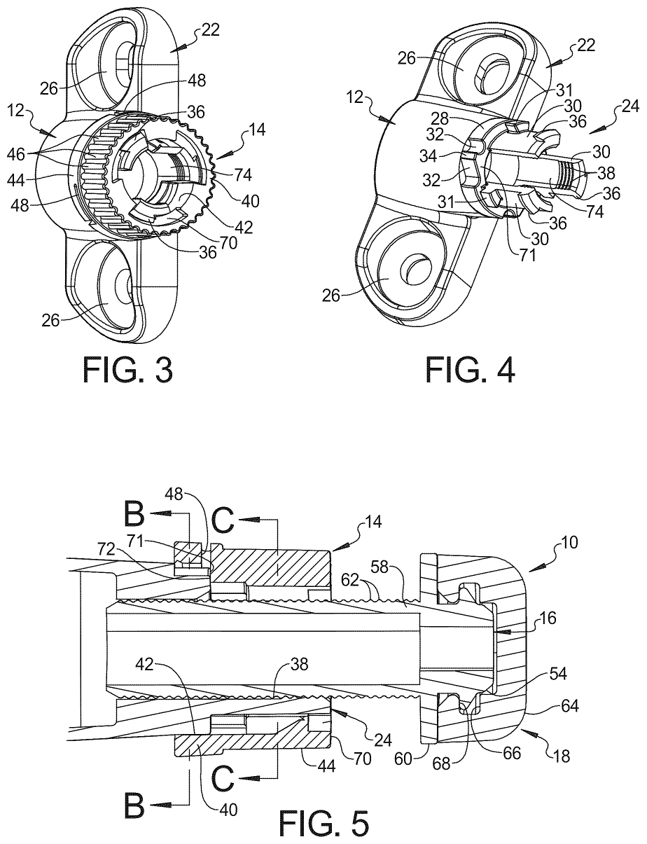

As best shown in FIGS. 2 and 3, the locking nut 14 has a hollow frustoconical (or annular) body 40 with an inner radial surface 42 and an outer radial surface 44, a plurality of knurls 46 projecting from the outer radial surface 44, and three L-shaped slots 48 extending radially through the body 40. The knurls 46 are equally spaced apart from one another around the circumference of the body 40. Similarly, the slots 48 are equally spaced apart from one another around the circumference of the body 40.

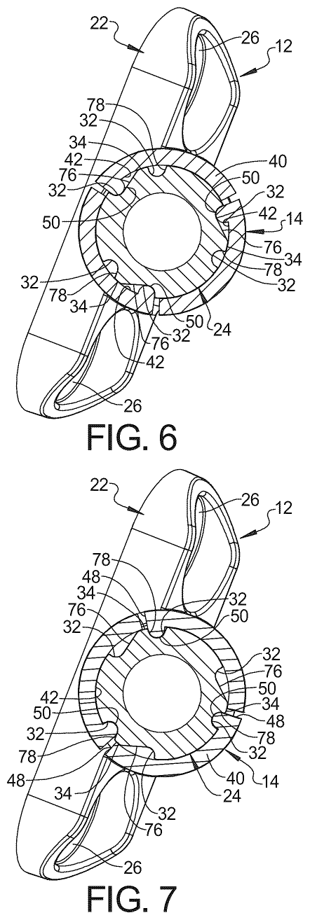

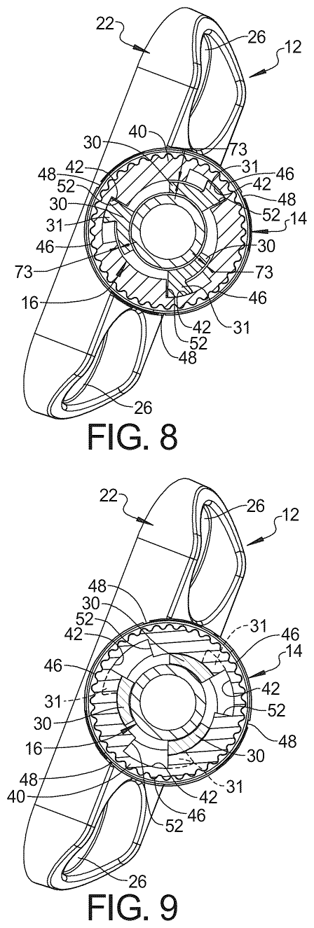

Referring briefly to FIGS. 6 and 7, the locking nut 14 also includes three positioning protrusions 50 that project from the inner radial surface 42 of the body 40. The positioning protrusions 50 are equally spaced apart from one another around the circumference of the body 40. Referring briefly to FIGS. 8 and 9, the locking nut 14 further includes three locking protrusions 52 that project from the inner radial surface 42 of the body 40 and are axially spaced apart from the positioning protrusions 50 (e.g., spaced apart from the positioning protrusions 50 along the longitudinal axis of the body 40). The locking protrusions 52 are equally spaced apart from one another around the circumference of the body 40.

Referring again to FIGS. 1 through 5, the stem 16 includes a head 54, a shank 58, and a disk-shaped flange 60 projecting radially outward from the shank 58. The shank 58 has external threads 62 in the form of annular ribs. The bump stop 18 has a dome-shaped body 64 with an internal cavity 66 and an annular flange 68 projecting radially inward from the body 64.

To assemble the bumper 10, the locking nut 14 is slid onto the cylindrical portion 24 of the base 12 past the retention flanges 36 on the fingers 30 of the base 12. In turn, the retention flanges 36 on the base 12 engage a first axial end surface 70 of the locking nut 14 and thereby retain the locking nut 14 on the base 12. As shown in FIGS. 4 and 5, the cylindrical portion 24 of the base 12 defines a ledge 71 that engages a second axial end surface 72 of the locking nut 14 and thereby prevents the locking nut 14 from being slid further onto the cylindrical portion 24 of the base 12 toward the oblong portion 22 of the base 12.

The base 12 and the locking nut 14 may be assembled together using a fixture to ensure that, when the locking nut 14 is slid onto the cylindrical portion 24 of the base 12, the locking nut 14 is in its unlocked position shown in FIGS. 6 and 8. In turn, the positioning protrusions 50 on the locking nut 14 are disposed within one of the grooves 32 in the base 12 as shown in FIG. 6, and the locking nut 14 can only be rotated in the direction from its unlocked position to its locked position due to the engagement between (i) the locking protrusions 52 and (ii) the fingers 30 and the rotational stops 31 shown in FIG. 8 (i.e., the locking nut 14 cannot be rotated counterclockwise in the orientation shown in FIG. 8 due to this engagement). In addition, as shown in FIG. 8, a radial gap 73 exists between the fingers 30 of the base 12 and the locking protrusions 52 of the locking nut 14, which allows the fingers 30 to deflect radially outward.

After the locking nut 14 is slid onto the cylindrical portion 24 of the base 12, the shank 58 of the stem 16 is inserted into a receptacle 74 formed by the fingers 30 of the base 12. In this regard, the cylindrical portion 24 of the base 12 may be referred to as a stem receiving portion. Before or after this step, the head 54 of the stem 16 is inserted into the internal cavity 66 of the bump stop 18. As best shown in FIG. 5, once the head 54 of the stem 16 is in the internal cavity 66 of the bump stop 18, the annular flange 68 inhibits the head 54 from being pulled back out of the internal cavity 66.

When the bumper 10 is assembled as shown in FIG. 1, the bumper 10 is mounted to the body panel by inserting the fasteners through the counterbores 26 in the base 12 and threading them into holes in the body panel. Then, when the closure panel is shut or closed for the first time, the closure panel pushes the stem 16 further into the receptacle 74 of the base 12. As this occurs, the fingers 30 act like a ratchet mechanism by deflecting radially outward and inward each time that one of the external threads 62 of the stem 16 moves past one (or one axially aligned set) of the internal threads 38 of the fingers 30. The external threads 62 of the stem 16 may be considered part of the ratchet mechanism. The ratchet mechanism allows the stem 16 to move into or out of the receptacle 74 of the base 12 in increments while inhibiting such axial movement.

After the closure panel is closed for the first time, the closure panel is opened and a person locks the axial position of the stem 16 (e.g., the position of the stem 16 along the longitudinal axis of the cylindrical portion 24) by rotating the locking nut 14 using the knurls 46 on the locking nut 14 (e.g., by hand). More specifically, the locking nut 14 is rotated clockwise about a quarter turn from its unlocked position shown in FIGS. 6 and 8 to its locked position shown in FIGS. 7 and 9. In turn, the positioning protrusions 50 on the locking nut 14 move past the retention protrusions 34 on the base 12 and into the other ones of the grooves 32 in the base 12. The slots 48 on the locking nut 14 enable the positioning protrusions 50 on the locking nut 14 to deflect radially outward so that the positioning protrusions 50 can move past the retention protrusions 34 on the base 12. The locking nut 14 is rotated clockwise until the locking protrusions 52 contact the rotational stops 31 on the outer radial surfaces of the fingers 30.

When the closure panel is closed, the bump stop 18 compresses due to the load applied by the closure panel. The bumper 10 may be designed so that, when the locking nut 14 is in its locked position, the force required to compress the bump stop 18 is less than the force required to move the external threads 62 of the stem 16 past each set of the internal threads 38 of the fingers 30. As a result, the bump stop 18 may be compressed to some degree anytime the closure panel is closed, which minimizes vibration of the closure panel.

When the locking nut 14 is in its locked position, there is no gap between the fingers 30 of the base 12 and the locking protrusions 52 of the locking nut 14. In turn, the fingers 30 are not allowed to deflect radially outward, and therefore the stem 16 cannot be moved axially relative to the base 12. The outer diameter of the fingers 30 is variable (i.e., the radial thickness of the fingers 30 varies around the circumference of the cylindrical portion 24) and/or the inner diameter of the locking protrusions 52 on the locking nut 14 is/are variable (i.e., the radial thickness of the locking protrusions 52 varies around the circumference of the body 40) so that the gap 73 is present when the locking nut 14 is in its unlocked position and the gap 73 is eliminated when the locking nut 14 is in its locked position.

To unlock the locking nut 14 so that bumper height may be reset, the locking nut 14 is rotated counterclockwise from its locked position to its unlocked position. A leading edge 76 of each retention protrusion 34 has a lesser slope angle than a trailing edge 78 of each retention protrusion 34 so that it is easier to rotate the locking nut 14 from its unlocked position to its locked position than to rotate the locking nut 14 from its locked position to its unlocked position. This inhibits the locking nut 14 from being inadvertently moved out of its locked position.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

As used herein, the term “and/or” includes any and all combinations of one or more of the associated listed items. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. An adjustable closure bumper comprising:
a base mountable to a body panel adjacent to an opening for a closure panel;
a stem insertable into a receptacle in the base;
a bump stop attached to one end of the stem for engaging the closure panel;
a ratchet mechanism that allows the stem to move into the receptacle in the base to adjust a height of the adjustable closure bumper while inhibiting movement of the stem out of the receptacle; and
a locking nut that fits over a portion of the base forming the receptacle and is rotatable relative to the base to lockout the ratchet mechanism and thereby set the height of the adjustable closure bumper.

2. The adjustable closure bumper of claim 1 wherein the base defines a pair of grooves spaced apart from one another around a perimeter of the base, and the locking nut includes a positioning protrusion that projects radially inward, the positioning protrusion disengaging one of the grooves and engaging the other one of the grooves when the locking nut is rotated between its unlocked position and its locked position.

3. The adjustable closure bumper of claim 2 wherein the base includes a retention protrusion disposed between the grooves about the perimeter of the base, and the locking nut defines a slot adjacent to the positioning protrusion, the slot enabling the positioning protrusion to deflect radially outward and move past the retention protrusion when the locking nut is rotated between its unlocked position and its locked position.

4. The adjustable closure bumper of claim 3 wherein a leading edge of the retention protrusion has a lesser slope angle than a trailing edge of the retention protrusion.

5. The adjustable closure bumper of claim 1 wherein the base includes a plurality of fingers that define the receptacle, each finger having internal threads that engage external threads on the stem and, as the stem is inserted into the receptacle in the base, the fingers are configured to deflect radially outward and inward each time that one of the external threads of the stem moves past one of the internal threads of the fingers, the fingers and the external threads of the stem forming the ratchet mechanism.

6. The adjustable closure bumper of claim 5 wherein:
the locking nut includes a plurality of locking protrusions that project radially inward;
the locking protrusions and the fingers are radially spaced apart by a gap when the locking nut is in its unlocked position; and
the gap is eliminated when the locking nut is in its locked position.

7. The adjustable closure bumper of claim 6 wherein the fingers have a variable outer diameter and the locking protrusions have a variable inner diameter.

8. The adjustable closure bumper of claim 6 wherein each finger includes a rotational stop disposed on an outer radial surface thereof, the rotational stops contacting the locking protrusions to stop rotation of the locking nut when the locking nut is rotated from its unlocked position to its locked position.

9. The adjustable closure bumper of claim 5 wherein each finger includes a retention flange, the retention flanges on the fingers engaging an axial end surface of the locking nut and thereby retain the locking nut on the base when the locking nut is slid onto the base past the retention flanges.

10. The adjustable closure bumper of claim 5 wherein, when the locking nut is in its locked position, the force required to compress the bump stop is less than the force required to move the external threads of the stem past the internal threads of the fingers.

11. The adjustable closure bumper of claim 1 wherein the base includes a cylindrical portion defining a ledge, the locking nut fits over the cylindrical portion of the base, and as the locking nut is slid onto the cylindrical portion, the ledge of the cylindrical portion engages an axial end surface of the locking nut and thereby prevents the locking nut from being slid further onto the cylindrical portion.

12. The adjustable closure bumper of claim 11 wherein the base further includes an oblong portion from which the cylindrical portion projects, the oblong portion having a pair of counterbores configured to receive fasteners for securing the base to the body panel.

13. The adjustable closure bumper of claim 1 wherein the ratcheting mechanism is formed by the base and the stem.

14. The adjustable closure bumper of claim 12 wherein the base and the stem are made from a plastic, the locking nut is made from a thermoplastic, and the bump stop is made from a rubber.

15. The adjustable closure bumper of claim 1 wherein the locking nut has an annular body with an inner radial surface, and outer radial surface, and a plurality of knurls projecting from the outer radial surface for rotating the locking nut by hand.

16. An adjustable closure bumper comprising:
a base mountable to a body panel adjacent to an opening for a closure panel, the base including a cylindrical portion having a receptacle;
a stem insertable into the receptacle in the base;
a bump stop attached to one end of the stem for engaging the closure panel; and
a locking nut that fits over the cylindrical portion of the base and is rotatable relative to the cylindrical portion between an unlocked position and a locked position, wherein the stem is axially moveable within the receptacle to adjust a height of the adjustable closure bumper when the locking nut is in its unlocked position, and the stem is axially immovable within the receptacle when the locking nut is in its locked position such that adjusting the locking nut from its unlocked position to its locked position sets the height of the adjustable closure bumper.

17. The adjustable closure bumper of claim 16 wherein the cylindrical portion of the base defines a pair of grooves spaced apart from one another around a perimeter of the cylindrical portion, and the locking nut includes a positioning protrusion that projects radially inward, the positioning protrusion disengaging one of the grooves and engaging the other one of the grooves when the locking nut is rotated between its unlocked position and its locked position.

18. The adjustable closure bumper of claim 17 wherein the cylindrical portion of the base includes a retention protrusion disposed between the grooves about the perimeter of the base, and the locking nut defines a slot adjacent to the positioning protrusion, the slot enabling the positioning protrusion to deflect radially outward and move past the retention protrusion when the locking nut is rotated between its unlocked position and its locked position.

19. The adjustable closure bumper of claim 16 wherein the base includes a plurality of fingers that define the receptacle, each finger having internal threads that engage external threads on the stem and, as the stem is inserted into the receptacle in the base, the fingers are configured to deflect radially outward and inward each time that one of the external threads of the stem moves past one of the internal threads of the fingers.

20. The adjustable closure bumper of claim 19 wherein:
the locking nut includes a plurality of locking protrusions that project radially inward;
the locking protrusions and the fingers are radially spaced apart by a gap when the locking nut is in its unlocked position; and
the gap is eliminated when the locking nut is in its locked position.
